(19) United States
(12) Patent Application Publication
(10) Pub. No.: US 2018/0212837 A1
(43) Pub. Date: Jul. 26, 2018

(54) NETWORK RESOURCE ALLOCATION BASED UPON NETWORK SERVICE PROFILE TRAJECTORIES

(71) Applicant: AT&T Intellectual Property I, LP., Atlanta, GA (US)

(72) Inventors: Sudhakar Kalluri, Cupertino, CA (US); Learie Hercules, San Francisco, CA (US)

(21) Appl. No.: 15/415,516

(22) Filed: Jan. 25, 2017

(51) Int. Cl. H04L 12/24; H04L 12/927; G06N 99/00; G06Q 30/02

(52) U.S. Cl. CPC H04L 41/16; G06Q 30/0202; G06N 99/005; H04L 47/808

(57) ABSTRACT

A method may include a processor of a telecommunication service provider network receiving a training data set including service profile trajectories for subscribers of the network, each including a network service profile of a subscriber over a plurality of time periods, where for a given time period, each network service profile includes indications of whether a subscriber is subscribed to a plurality of network services. The processor may further create a predictive model based upon the training data set to predict whether a subject subscriber will be subscribed to a given network service at a designated future time period, receive a service profile trajectory for the subject subscriber, apply the service profile trajectory to the predictive model to generate a prediction of whether the subject subscriber will be subscribed to the given network service at the designated future time period, and allocate a network resource based upon the prediction.

The present disclosure relates generally to predicting network services that will be utilized by subscribers of a telecommunication service provider network, and more particularly to automatically allocating network resources based upon the subscribers' network service profile trajectories.

### BACKGROUND

Various types of organizations endeavor to retain existing customers and to have customers retain existing subscription-based products and services. In addition, organizations endeavor to sell new products and services to existing customers. However, a one-size-fits-all approach may be inefficient in terms of achieving such results. Budget limitations may necessitate trade-offs between marketing and customer care efforts that are directed to existing customers and efforts targeting the acquisition of new customers.

### SUMMARY

In one example, the present disclosure provides a device, computer-readable medium, and method for applying a network service profile trajectory for a subscriber to a predictive model to generate a prediction of whether the subscriber will be subscribed to a given network service at a designated future time period. For example, a processor of a telecommunication service provider network may receive a training data set comprising network service profile trajectories for a plurality of subscribers of the telecommunication service provider network. In one example, each of the network service profile trajectories includes a network service profile of one of the plurality of subscribers over a plurality of time periods, where, for a given time period of the plurality of time periods, each of the network service profiles includes indications of whether a subscriber is subscribed to a plurality of network services of the telecommunication service provider network during the given time period. The processor may further create a predictive model based upon the training data set to predict whether a subject subscriber will be subscribed to a given network service of the plurality of network services at a designated future time period, receive a network service profile trajectory for the subject subscriber, and apply the network service profile trajectory for the subject subscriber to the predictive model to generate a prediction of whether the subject subscriber will be subscribed to the given network service at the designated future time period. The processor may also allocate a network resource of the telecommunication service provider network based upon the prediction of whether the subject subscriber will be subscribed to the given network service at the designated future time period.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication service provider network, according to the present disclosure;

FIG. 2 illustrates an example of a subscriber network service profile trajectory, according to the present disclosure;

FIG. 3 illustrates an example mathematical representation of a workflow for generating and applying a predictive model, according to the present disclosure;

FIG. 4 illustrates an example flowchart of a method for applying a service profile trajectory for a subscriber to a predictive model to generate a prediction of whether the subscriber will be subscribed to a given network service at a designated future time period; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses devices, non-transitory (i.e., tangible or physical) computer-readable storage media, and methods for applying a network service profile trajectory for a subscriber to a predictive model to generate a prediction of whether the subscriber will be subscribed to a given network service at a designated future time period.

Various types of organizations endeavor to retain existing customers and to have customers retain existing subscription-based products and services. In addition, organizations endeavor to sell new products and services to existing customers. However, a one-size-fits-all approach may be inefficient in terms of achieving such results. Budget limitations may necessitate trade-offs between marketing and customer care efforts that are directed to existing customers and efforts targeting the acquisition of new customers. In addition, an organization may only learn that a customer is planning to drop or downgrade a service when the customer contacts the organization to make the change. At this point, any response by the organization to change the customer's mind may be too little, too late.

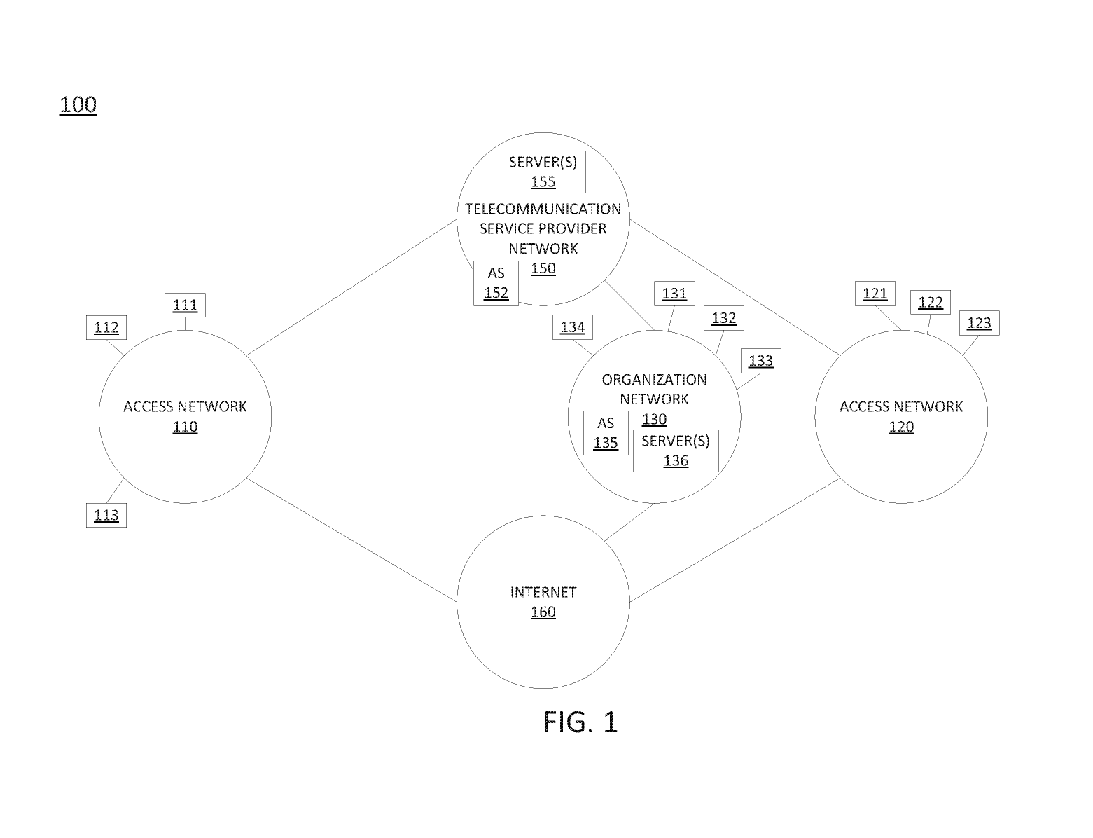

Examples of the present disclosure create a machine-learning predictive model based upon network service profile trajectories of telecommunication service provider network subscribers to predict a subscriber's likelihood of discontinuing a specified service within a specified time period or to predict a likelihood, or propensity to adopt a specified new service within a given time period. Broadly, the predictive model is for determining whether the subscriber will be subscribed to a given network service at a designated future time period. In one example, the predictive model may be further based upon subscribers' demographics data and/or service usage data. In one example, a network resource of the telecommunication service provider network may be allocated based upon the prediction of whether the subject subscriber will be subscribed to the given network service at the designated future time period, e.g., the third month from the present time period, the sixth month from the present time period, etc. The allocation of the network resource may include, for example, the activation of a new application server hosted on network function virtualization infrastructure (NFVI), the activation of a remote radio head (RRH), the allocation of a baseband unit (BBU), the invocation of a marketing automation platform to direct communications to devices of the subscriber, and so forth. In addition, in one example, the allocation of the network resource may be further based upon predictions in accordance with the predictive model of whether a plurality of additional subscribers will be subscribed to the given network service at the designated future time period. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure for applying a network service profile trajectory for a subscriber to a predictive model to generate a prediction of whether the subscriber will be subscribed to a given network service at a designated future time period may operate in accordance with the present disclosure. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office. In one example, telecommunication service provider network 150 may also include an application server (AS) 152 and one or more servers 155, as described in greater detail below. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113 and 121-123, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160.

For example, one or both of access networks 110 and 120 may comprise an ISP network, such that 111-113 and/or 121-123 may communicate over the Internet 160, without involvement of telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like.

In one example, the access networks 110 and 120 may be different types of access networks. In another example, the access networks 110 and 120 may be the same type of access network. In one example, one or more of the access networks 110 and 120 may be operated by the same or a different service provider from a service provider operating telecommunication service provider network 150. For example, each of access networks 110 and 120 may comprise an Internet service provider (ISP) network, a cable access network, and so forth. In another example, each of access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide mobile core network 130 functions, e.g., of a public land mobile network (PLMN)-universal mobile telecommunications system (UMTS)/General Packet Radio Service (GPRS) core network, or the like. In still another example, access networks 110 and 120 may each comprise a home network, which may include a home gateway, which receives data associated with different types of media, e.g., television, phone, and Internet, and separates these communications for the appropriate devices. For example, data communications, e.g., Internet Protocol (IP) based communications may be sent to and received from a router in one of access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs) and/or home networks, and the like.

In one example, organization network 130 may comprise a local area network (LAN), or a distributed network connected through permanent virtual circuits (PVCs), virtual private networks (VPNs), and the like for providing data and voice communications. In one example, organization network 130 links one or more endpoint devices 131-134 with each other and with Internet 160, telecommunication service provider network 150, devices accessible via such other networks, such as endpoint devices 111-113 and 121-123, and so forth. In one example, endpoint devices 131-134 comprise devices of organizational agents, such as customer service agents, or other employees or representatives who are tasked with addressing customer-facing issues on behalf of the organization that provides organization network 130. In one example, endpoint devices 131-134 may each comprise a telephone for analog or digital telephony, a mobile device, a cellular smart phone, a laptop, a tablet computer, a desktop computer, a bank or cluster of such devices, and the like.

In one example, any one or more of endpoint devices 131-134 may comprise software programs, logic or instructions for providing a customer service interaction chat conversation interface for facilitate interactive customer service communications between customers and customer service agents, e.g., as an alternative or in addition to telephony or voice communications. In this regard, voice calls and interactive chat conversations between customers and organizational agents may be facilitated via one or more of telecommunication service provider network 150 and Internet 160.

In one example, organization network 130 may be associated with the telecommunication service provider network 150. For example, the organization may comprise the telecommunication service provider, where the organization network 130 comprises devices and components to support customer service representatives, and other employees or agents performing customer-facing functions. For instance, endpoint devices 111-113 and 121-123 may comprise devices of customers, who may also be subscribers in this context. In one example, the customers may call via a telephone or engage in text or multi-media based chat conversations via endpoint devices 111-113 and 121-123 with customer service representatives using endpoint devices 131-134.

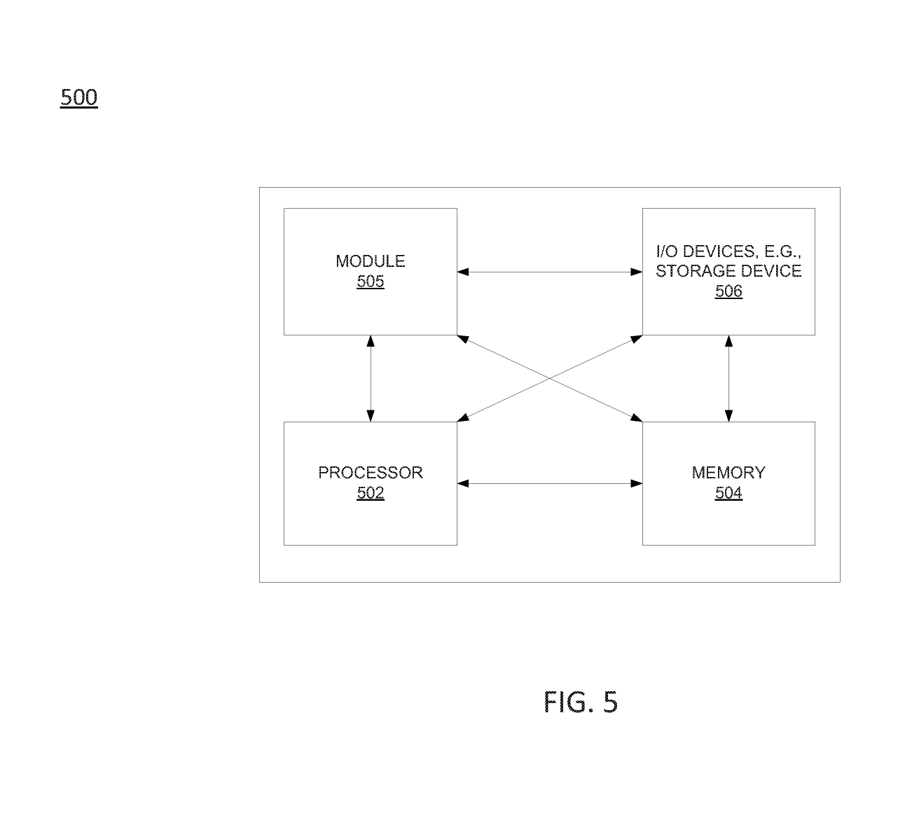

In one example, organization network 130 may also include an application server (AS) 135. In one example, AS 135 may comprise a computing system, such as computing system 500 depicted in FIG. 5, and may be configured to provide one or more functions for applying a network service profile trajectory for a subscriber to a predictive model to generate a prediction of whether the subscriber will be subscribed to a given network service at a designated future time period, in accordance with the present disclosure. Similarly, in one example, AS 152 in telecommunication service provider network 150 may comprise a computing system, such as computing system 500 depicted in FIG. 5, and may be configured to provide one or more functions for applying a network service profile trajectory for a subscriber to a predictive model to generate a prediction of whether the subscriber will be subscribed to a given network service at a designated future time period, in accordance with the present disclosure. For example, AS 152 or AS 135 may be configured to perform one or more steps, functions, or operations in connection with the example method 400 described below. Thus, as described herein, functions of AS 152 may alternatively be performed by AS 135, and vice versa.

In addition, it should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

In one example, the system 100 may also include one or more servers 136 and/or one or more servers 155 in organization network 130 and telecommunication service provider network 150, respectively. In one example, the servers 136 and/or 155 may each comprise a computing system, such as computing system 500 depicted in FIG. 5, and may be configured to host one or more centralized system components for gathering and/or storing customers' network service profile data, demographic data, and/or service usage data (such data collectively comprising “customer traits”), in accordance with the present disclosure. For example, a first centralized system component may comprise a database of assigned telephone numbers, a second centralized system component may comprise a database of basic customer account information for all or a portion of the customers/subscribers of the telecommunication service provider network 150, a third centralized system component may comprise a cellular network service home location register (HLR), e.g., with current serving base station information of various subscribers, and so forth. Other centralized system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In one example, servers 136 and/or 155 may include a marketing automation platform for sending automated communications to endpoint devices 111-113 and 121-123. It should be noted that in one example, a centralized system component may be hosted on a single server, while in another example, a centralized system component may be hosted on multiple servers, e.g., in a distributed manner.

In accordance with the present disclosure, in one example, AS 152 (and/or AS 135) may collect customers' network service profile data for a plurality of time periods, as well as customers' demographic data and/or service usage data for the plurality of time periods from one or more centralized system components (e.g., servers 155 and/or servers 136) for customers associated with endpoint devices 111-113 and 121-123. In one example, the centralized system components may forward the network service profile data, demographic data and/or service usage data to AS 152 (and/or AS 135) on a periodic basis, when a certain quantity of data has been collected and is ready to transmit, etc. Alternatively, or in addition, AS 152 (and/or AS 135) may query the centralized system component(s), e.g., periodically or on some other basis, in order to retrieve the network service profile data, demographic data and/or service usage data. In one example, data may be aggregated over a plurality of devices of a single customer. In another example, a “customer” may comprise a household having a number of devices which may be used by respective household members, or which may be shared by household members. In either case, the demographic data may be aggregated for a plurality of household members and/or the service usage data may be aggregated for multiple endpoint devices associated with the customer.

As described in greater detail below, AS 152 (and/or AS 135) may then create a predictive model for a given network service and for a designated future time period based upon customers' network service profile data, demographic data, and/or service usage data, and apply a network service profile trajectory, demographic data, and/or service usage data for a customer to the predictive model to generate a prediction of whether the customer will be subscribed to the given network service at the designated future time period. In addition, it should be realized that the system 100 may be implemented in a different form than that illustrated in FIG. 1, or may be expanded by including additional endpoint devices, access networks, network elements, application servers, etc. without altering the scope of the present disclosure.

The following describes operations to create a predictive model for a given network service and for a designated future time period based upon customers' network service profile data, demographic data, and/or service usage data. The following also describes operations to apply a network service profile trajectory, demographic data, and/or service usage data for a customer to the predictive model to generate a prediction of whether the customer will be subscribed to the given network service at the designated future time period, and operations to allocate a network resource based upon the prediction. In one example, the following operations may be performed by AS 152 (and/or AS 135) of FIG. 1, or by a computing system 500 depicted in FIG. 5 that is configured to provide one or more functions for applying a network service profile trajectory for a subscriber to a predictive model to generate a prediction of whether the subscriber will be subscribed to a given network service at a designated future time period, in accordance with the present disclosure.

As mentioned above, network service profile data, demographic data, and network service usage data may be collected within a telecommunication service provider network for a plurality of customers (broadly, “subscribers”). For each customer, the network service profile data may include records which indicate whether or not a customer is subscribed to each of a plurality of network services, such as a wireless phone service, a wireless data service, a home phone service, a home broadband data service, a home television service, a satellite television service, a satellite data service, a data storage service, a home security monitoring service, one or more television service bundles, and so forth.

In one example, the demographic data may include records of: a customer's home address, zip code, region, etc., a number of members of a household, the constitution of the household members (e.g., number of adults, number of children, number of seniors, ages, sexes, etc.), an income and/or wealth tier, a number of network-connected devices utilized by the customer and/or household, the types of network-connected devices, occupation(s), and so forth. In one example, the service usage data from a trouble ticket system may include: information regarding trouble tickets generated with respect to telecommunication services for the customer, e.g., the number of tickets in a given time period, the time to resolve each of the trouble tickets, the number of times the customer was contacted in order to resolve each of the trouble tickets, the number of times the customer called in connection with resolving the trouble ticket, and so forth. Other types of service usage data may include records of: a number of phone calls made, received, answered, dropped, etc., a number of local and/or long distance calls made, an average call duration, a total number of voice call minutes utilized, a number of text messages sent, received, etc., a data volume utilized for home broadband service and/or mobile data service, excess network resource utilization (e.g., excess voice usage, excess text or multimedia message usage, excess data usage, excess bandwidth usage, and so forth), television channels and/or live programs viewed, particular media contents recorded, e.g., via a DVR, media contents selected via an on-demand service of the telecommunication service provider, particular applications downloaded and/or installed on a customer's device, and so forth.

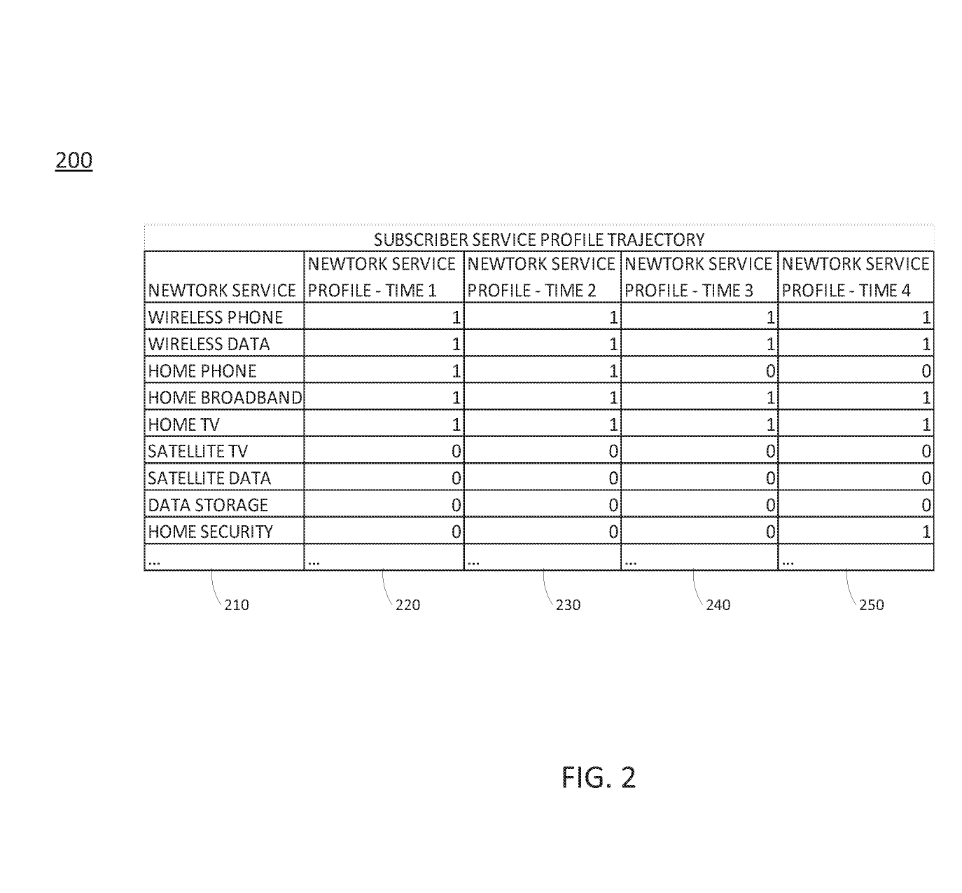

In one example, the customers' network service profile data (and in some cases the customers' service usage data and/or demographic data) may be utilized to create a predictive model for predicting whether a subscriber will be subscribed to a given network service at a designated future time period. In one example, the customers' network service profile data, service usage data and/or demographic data) may comprise a training data set that is input to a machine learning algorithm to create the predictive model. In one example, the customers' network service profile data may relate to a plurality of time periods, and may collectively be referred to as a “service profile trajectory”. In one example, for a given time period of the plurality of time periods, each of the network service profiles includes indications of whether a customer is subscribed to a plurality of network services of the telecommunication service provider network during the given time period. As described in greater detail below, FIG. 2 depicts an example customer/subscriber service profile trajectory 200.

The predictive model may be generated from the training data set in a variety of ways. For instance, the purpose of the machine learning algorithm may be to generate a classifier, such as a support vector machine (SVM), e.g., a binary classifier and/or a linear binary classifier, a multi-class classifier, a kernel-based SVM, etc., a distance-based classifier, e.g., a Euclidean distance-based classifier, or the like, that may be used to identify customers who are predicted to be subscribed to a given network service at a designated future time period. In other words, the predictive model may comprise the classifier.

In one example, with respect to a new network service, the test data set may be associated with customers from a test market where the new network service was introduced or made available. The test market may include a specific geographic area, such as a city or state, or may comprise customers from a particular market segment, e.g., a tier of longest tenured customers, customers in a particular income band, customers having households with at least two children under age 10, and so forth. In one example, the test data set may be divided into positive examples and negative examples. For instance, if the designated future time period is the sixth month from the present time, the test data set may include data from a most recently passed six month period. In another example, the test data set may include data from a longer time period, e.g., 1.5 times the duration from the present to the designated future time, e.g., 9 months based upon the present scenario, two times the duration from the present to the designated future time, and so forth. In one example, a “reference ‘present’” time period may be set for the test data. For instance, if the test data includes six months of data, the “reference ‘present’” time period may be set to the earliest time for which the test data is collected. In another example, if the test data includes nine months of data, the “reference ‘present’” time period may be set to the third month, for example.

Positive examples may comprise a customer (and all of the test data associated with the customer) who is subscribed to the network service at a “reference ‘designated future time period’.” For instance, the “reference ‘designated future time period’” may be the sixth month from the “reference ‘present’” time period. The customer may be determined to be subscribed to the network service or not subscribed to the network service by referring to the customer's network service profile data of the customer's network service profile trajectory for the sixth month from the “reference ‘present’” time period.

Thereafter, in one example, the machine learning algorithm may utilize the set of training data (excluding any data from the “reference ‘designated future time period’”) as a plurality of data points, or “customer traits.” For instance, the network service profile data for each time period covered by the training data set may comprise a separate data point. In one example, customers' demographic data and/or network service usage data of the training data set related to each time period covered by the training data set may also comprise separate data points. In one example, the training data set may be pre-processed into a format for use in the machine learning algorithm. For example, a customer's network service usage data may include a record that the customer placed 15 long distance calls in the month of January. In one example, a data point of the training data set may distinguish between customers placing more or less than 10 long distance calls within a month, e.g., if a customer placed less than 10 long distance calls in the month, the data point may contain an entry of “−1,” while if the customer placed 10 or more long distance calls in the month, the data point may contain an entry of a “1”. In another example, there may be separate data points for less than 10 long distance calls in a month, 10 to 20 long distance calls in the month, or more than 20 long distance calls in the month. If the customer placed 15 long distance calls in the month, the corresponding data points may be populated as: {−1, 1, −1} respectively.

Other aspects of demographic data and service usage data may be similarly pre-processed. For instance, demographic data may include records of customers' tenures as subscribers with the telecommunication service provider network. The customers may be segregated into tiers, with corresponding data points, e.g., less than 2 years, 2 to 5 years, and more than 5 years, and so forth. Thus, customer demographic data for a customer with three years of tenure may have three corresponding data points of {−1, 1, −1}. In an example where the classifier comprises a support vector machine (SVM), the machine learning algorithm may calculate a hyper-plane in a hyper-dimensional space representing the features space of all possible customer traits. The hyper-plane may define a boundary in the feature space which separates positive examples from negative examples. However, it should be noted that the present disclosure is not limited to binary data points in the training data set. For instance, in a multi-class classifier, a data point for customer tenure may range from 0 to 15 years, 20 years, or more. In addition, in a distance-based classifier, values for the data point may range from zero to a maximum tenure, e.g., 20 years, 30 years, or an arbitrary number of years, e.g., a maximum of 99 years.

Once a classifier, or “predictive model,” is generated for a particular network service and for a particular designated future time period, the classifier may be applied to additional customers of the telecommunication service provider network to classify the customers into one of two categories, e.g., customers who may be more likely to subscribed to the network service at the designated future time period and customers who may be less likely to be subscribed to the network service at the designated future time period. For instance, the customer traits for a customer (e.g., network service profiles/network service profile trajectory, demographic data, network service usage data, etc.) may be quantified and applied to the classifier. For instance, the set of customer traits for the customer may comprise a vector in the feature space, and the classifier may be used to determine on which “side” of the hyper-plane the vector lies. As such, the classifier may determine whether the customer is likely or unlikely to be subscribed to the network service at the designated future time period based upon the result of the classification. In one example, a confidence score may be calculated and provided along with the classification. For instance, a distance between the vector representing the customer and the hyperplane may be calculated. Thereafter, the confidence score may be calculated from the distance. For example, the confidence score may be proportional to the distance. The greater the distance, the higher the confidence score. In one example, the relationship between the distance and the confidence score may be empirically set.

It should be noted that variations of the above described process may be implemented in accordance with the present disclosure. For example, if there are comparatively few positive examples or few negative examples, e.g., less than 20 percent, less than 15 percent, etc., a greater or lesser percentage of positive examples or negative examples may be utilized from the training data set as inputs to the machine learning algorithm to effect a positive example weighting or negative example weighting.

In another example, the feature space may comprise a reduced feature space that may be determined by first performing feature selection over a number of customer traits. For example, a feature selection process may include reducing the number relevant features (e.g., customer traits) to those which are most useful in a classifier to segregate customers who are likely to be subscribed to the network service at the designated future time period from those who are not. Thus, for example, a customer trait, or “feature,” with a higher number of positive examples may be selected for inclusion in a reduced “feature set” over a customer trait with fewer or no positive examples, where the feature set may include features comprising dimensions within the reduced feature space. However, it should be noted that a customer trait that is strongly associated with negative examples may also be included in the reduced feature set. For instance, if no customer in the training data set having a certain model of cellular telephone was subscribed to the network service at the “reference ‘designated future time period’”, this customer trait may comprise a strong feature for the binary decision making of the classifier and may also be selected for inclusion. Alternatively, or in addition, a principal component analysis (PCA) may be applied to the training data set. For instance, PCA may be applied to a hyper-dimensional space of all of the possible features (e.g., customer traits) that may be included in the feature set. In another example, PCA may be applied to a hyper-dimensional space based upon a reduced feature set (e.g., a “reduced feature space”). In one example, a hyper-plane in the hyper-dimensional space (e.g., with or without PCA transformation) may be generated to represent an average of the values for various customer traits for all of the positive examples.

In one example, a portion of the training data set may be set aside for use as a testing data set may be used to verify the accuracy of the classifier. For example, customer service profile trajectories, demographics data, and/or service usage data for various customers in the testing data set may be input to the classifier. In one example, the customer service profile trajectories, demographics data, and/or service usage data of the testing data set may be transformed to conform to a reduced feature set and/or to conform to a hyper-dimensional space generated via PCA using the training data set. The classifier may generate an output comprising categorizations of each customer in the testing data set as belonging to either a first class or a second class. The first class may comprise, for example, customers who are similar to those customers in the training data set who are positive examples, i.e., customers subscribed to the network service at the “reference ‘designated future time period’.” The second class may comprise negative examples, i.e., customers similar to those customers of the training data set who were not subscribed to the network service at the “reference ‘designated future time period’.” The output may be compared to the known categorizations of the customers in the testing data set. For instance, the customers in the testing data set may be known to be either subscribed to the network service at the “reference ‘designated future time period’” or not. Thus, a percentage accuracy score may be calculated for the classifier. In one example, if the accuracy of the classifier is less than a desired accuracy, the feature selection and/or PCA may be re-run on the training data set, or the portion of the training data set used as inputs to the machine learning algorithm to train the classifier may be expanded to include network service profile trajectories, service usage data, and/or demographic data for additional positive example customers, or a larger number of customers in general.

It should also be noted that in other, further, and different examples, variations of one or more of the above described operations may be implemented in accordance with the present disclosure. For example, a decision tree algorithm may be used instead of a SVM-based binary classifier. In another example, a binary k-nearest neighbor algorithm may be utilized. In still another example, a distance-based classifier may be used. For example, the machine learning algorithm may comprise a clustering algorithm over positive examples to generate a vector in a hyper-dimensional space representing the average of the positive examples. In other words, the vector may represent the “average” of the customer traits of positive example customers. Classification of additional customers may then comprise generating a vector representing the customer traits of the customer, and calculating a Euclidean distance or cosine distance/similarity from the vector representing the “average” of the positive example customers. In one example, customers for which the distance calculated is less than (or equal to) a threshold distance may be considered to be likely to be subscribed to the network service, while customers for which the distance calculated is greater than (or equal to) the threshold distance may be considered to be not likely to be subscribed to the network service. In one example, a confidence score of the prediction may further be calculated, e.g., where the confidence score is proportional to the distance between the vector representing the customer traits of the customer and the vector representing the “average” of the positive example customers. Thus, these and other modifications are all contemplated within the scope of the present disclosure.

It should be noted that a similar process, or processes, may be followed to generate different classifiers for the same network service for different designated future time periods. For example, the telecommunication service provider network may release a new network service and would like to identify customers who are likely to subscribe and/or to be subscribed to the new network service. The telecommunication service provider network may further wish to identify when each of the customers are likely to subscribe to the new network service. Different classifiers may be created for different designated future time periods. Then, for a given customer, the customer's service profile trajectory (and in some cases, the customer's demographic data and service usage data) may be applied to each of the classifiers. The subscriber may be identified as being likely to subscribe to the network service at a particular future time period by determining from the classifier results when the prediction changes from “likely to be not subscribed” to “likely to be subscribed.” For example, if the result for the given customer for a classifier associated with a third month from the present indicates that the customer is not likely to be subscribed to the new network service, but the result for the given customer for a classifier associated with a fourth month from the present indicates that the customer is likely to be subscribed to the new network service, the transition in the result from the third month to the fourth month may result in a determination that the subscriber is likely to subscribe to the new network service at the fourth month. In the foregoing example, the set of classifiers for the network service with respect to a plurality of future time periods may collectively be referred to as a “predictive model.”

In one example, a network resource may be allocated based upon the determination of the time period in the future when the customer is determined to be likely to be subscribe to the new network service. In addition, in one example, a similar process may be followed with respect to at least one additional customer, and the allocation of the network resource may be based upon the determinations of one or more time periods in the future when various customers are determined to be likely to subscribe to the new network service. For example, the allocation of the network resource may include the activation of a new application server hosted on network function virtualization infrastructure (NFVI), the activation of a remote radio head (RRH), the allocation of a baseband unit (BBU), and so forth. For instance, if the new network service is a cloud storage service, and if more than a certain number of subscribers in a certain area or region are determined to become subscribers to the network service within the next three months, next four months, etc., one or more new storage servers may be configured and/or activated within a portion of the telecommunication service provider network that is suitable for servicing the customers in the region who are anticipated to become subscribers.

In another example, the allocation of the network resource may include the invocation of a marketing automation platform to direct communications to at least one device of the customer, or to a plurality of customers who are anticipated to become subscribers to the service within the next three months, next four months, etc. In one example, the marketing automation platform may be directed to send communications, e.g., automated phone calls, text messages, emails, and so forth, to a customer at a time prior to the time period in the future when the customer is determined to be likely to subscribe to the new network service. For instance, if the classifier(s), or predictive model, determines that a customer is likely to subscribe to a new network service six months from the present time, the marketing automation platform may be directed to send communications, e.g., marketing communications offering the new network service and/or offering a free trial or discount for the new network service within two months, within three months, or at any other time prior to the sixth month. In other words, the predictive model may identify a customer who is likely to subscribe to the new network service and a future time period at which the customer is likely to become a subscriber, where automated marketing communications may be directed to the customer at an earlier time, e.g., to potentially enroll the customer as a subscriber at an earlier time period that that which is predicted via the predictive model.

In one example, the allocation of the network resource may be further based upon a confidence score of the classification of a customer in accordance with the predictive model, or the confidence scores with respect to a plurality of customers. For example, a marketing automation platform may be invoked with respect to customers determined to be likely to subscribe to a new network service at one or more future time periods and with confidence scores greater than a threshold, e.g., greater than 60 percent, greater than 75 percent, etc. Similarly, a new application server may be deployed in connection with a network service when greater than a threshold number of customers in an area are determined to be likely to subscribe to a new network service at one or more future time periods and with confidence scores greater than a threshold. Alternatively, or in addition, customers determined to be likely to become new subscribers to a network service may be ranked based upon confidence scores. Then a number of customers from the top (or bottom) of the list may be selected to receive communications from a marketing automation platform. For instance, out of 1000 customers determined to be likely to become new subscribers to a network service within the next six months, the next nine months, etc., the 200 customers with the highest confidence scores (e.g., the top 20 percent) may be selected to receive communications from a marketing automation platform in advance of the respective time periods for which the respective customers are determined to be likely to become new subscribers to the network service.

The foregoing is described primarily in connection with examples of new network services being added in a telecommunication service provider network. However, other examples of the present disclosure may relate to predicting whether and/or when a customer may be likely to not be a subscriber to a network service and/or to drop an existing network service to which the customer is a subscriber. For instance, the customer network service profiles/network service profile trajectories of customers in a test market may be used as a training data set to create a classifier for classifying whether a customer is likely to not be subscribed to a network service at a designated future time period. Positive examples for training the classifier may comprise customers having a network service profile associated with a “reference ‘designated future time period’” that indicates the customer is not a subscriber to the network service at that time. Negative examples, may comprise customers having a network service profile associated with a “reference ‘designated future time period’” that indicates the customer is a subscriber to the network service at that time. It should be noted, however, that a classifier created in connection with positive examples being associated with customers who are subscribed to the network service at the “reference ‘designated future time period’” may alternatively or additionally be used to identify customers who are likely to be not subscribed to the network service at a designated future time period.

In one example, multiple classifiers regarding the network service may be created with respect to a plurality of time periods, and may be used collectively as a predictive model to predict not only whether a customer is likely to not be a subscriber to a network service, but also to predict when customers who are current subscribers to the network service are likely to drop the network service. For example, if the predictive model determines a customer who is a current subscriber to a network service is likely to drop the network service, and that the customer is most likely to drop the network service nine months from the present time, a network resource may be allocated based upon such a determination. For instance, a marketing automation platform may be invoked to send communications to one or more devices of the customer prior to the ninth month offering a discount for the network service, providing content explaining features and benefits of the network service, and so forth. In another example, the network service may comprise a legacy service which the telecommunication service provider network is already attempting to phase out. In such case, the allocation of the network resource may comprise decommissioning an application server or other network-based component, e.g., implemented on network function virtualization infrastructure (NFVI), and/or re-allocating the network resource to other applications. Thus, these and other modifications are all contemplated within the scope of the present disclosure.

FIG. 2 illustrates an example subscriber service profile trajectory 200, in accordance with the present disclosure. As illustrated in FIG. 2, the subscriber service profile trajectory 200 includes a plurality of network service profiles (220, 230, 240, and 250) relating to different time periods, e.g., time 1, time 2, time 3, and time 4. The network service profiles (220, 230, 240, and 250) include entries in each row for different network services which are labeled in the column 210. For instance, entries of “1” indicate that the subscriber was subscribed to the network service of the row at the time period associated with the given column of the entry. A “0” indicates that the subscriber was not subscribed to the network service at the associated time period. It should be noted that in a different example “1” and “−1” may be used as respective entries instead of “1” and “0.” For instance, a binary classifier that is created in accordance with the present disclosure may utilize “1” and “−1” as labels. Accordingly, in one example, the subscriber service profile directory 200 may efficiently utilize the same labels. Thus, no transformation of the labels of the subscriber service profile directory 200 may be required to place the data in a condition for use in connection with the classifier.

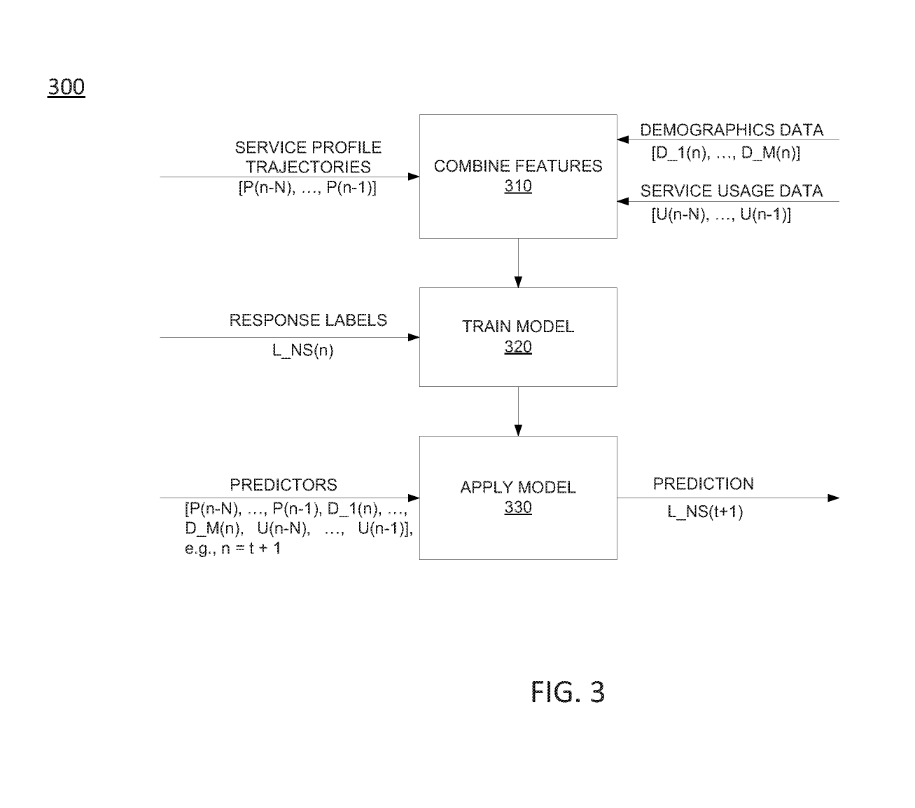

To further aid in understanding the present disclosure, FIG. 3 illustrates a mathematical representation of a workflow 300 for generating and applying a predictive model, in accordance with the present disclosure. In block 310, customer traits, e.g., network service profile trajectories [P(n−N), . . . , P(n−1)], demographics data D(n) and/or service usage data [U(n−N), . . . , U(n−1)] for a plurality of customers are combined into a training data set, e.g., a series of “predictors.” In the present example, the network service profile trajectories and service usage data for each customer includes network service profiles and service usage data for a plurality of time periods n−N to n−1, where t=n is a current time period, and where “t=n−N, . . . , n−1” comprise historical time periods, or time increments. The time periods/increments may comprise one day, one week, one month, etc. In the present example, there may be K possible network services {1, 2, . . . , K}, not counting a “new service” NS, where P(t)=S_1(t), . . . , S_K(t), t={n−N, . . . , n−1} and indicates for each service {S_1, . . . S_K} whether that network service was active for the customer or not at a particular time “t.” In one example, demographics data D(n)=[D_1(n), . . . , D_M(n)] is extracted as of a point in time (e.g., halfway back in time, such as at t=n−(N/2)) in the chosen historical period relative to the current time t=n.

In block 320, the predictive model, e.g., a classifier, is trained in accordance with the training data set, e.g., predictors [P(n−N), . . . , P(n−1), D_1(n), . . . , D_M(n), U(n−N), . . . , U(n−1)] and response variables/labels L_NS(n) for customers in the training data set. For each customer in the training data set, the response variable or label L_NS(n) is an indicator variable describing whether the customer adopted the new service (L_NS(n)=1) or not (L_NS(n)=0) at time t=n.

In block 330, the classifier, or predictive model is applied to predictors, e.g., customer traits, for one or more additional customers to generate one or more predictions. For example, predictors for an additional customer [P(n−N), . . . , P(n−1), D_1(n), . . . , D_M(n), U(n−N), . . . , U(n−1)], where n=t+1 may be applied to the predictive model/classifier to generate a prediction L_NS(t+1) for a future time period (e.g., one time increment in the future). If n=t+6, a prediction L_NS(t+6) may be generated for a future time period six time increments in the future, and so forth.

Various modifications or additions may be incorporated with respect to the example workflow 300. For example, demographic features can be assumed to be constant over the chosen historical period (as described above), or can be generalized to time-varying demographics similar to the subscribers' network services profile trajectories. The predictive model can be a binary classification model, so that a particular customer is either targeted or not for allocation of a network resource. Alternatively, a continuous (or ordinal) score can be developed for each customer. For instance, if the network resource to be allocated comprises a marketing automation platform, the customer score can inform the “intensity or frequency” at which the customer is contacted. In still another example, instead of creating a predictive model to determine whether customers will add, drop, and/or retain new or existing network services, the predictive model may alternatively be created to predict whether and/or when customers may upgrade or downgrade a level of service for a network service to which the customers are subscribed.

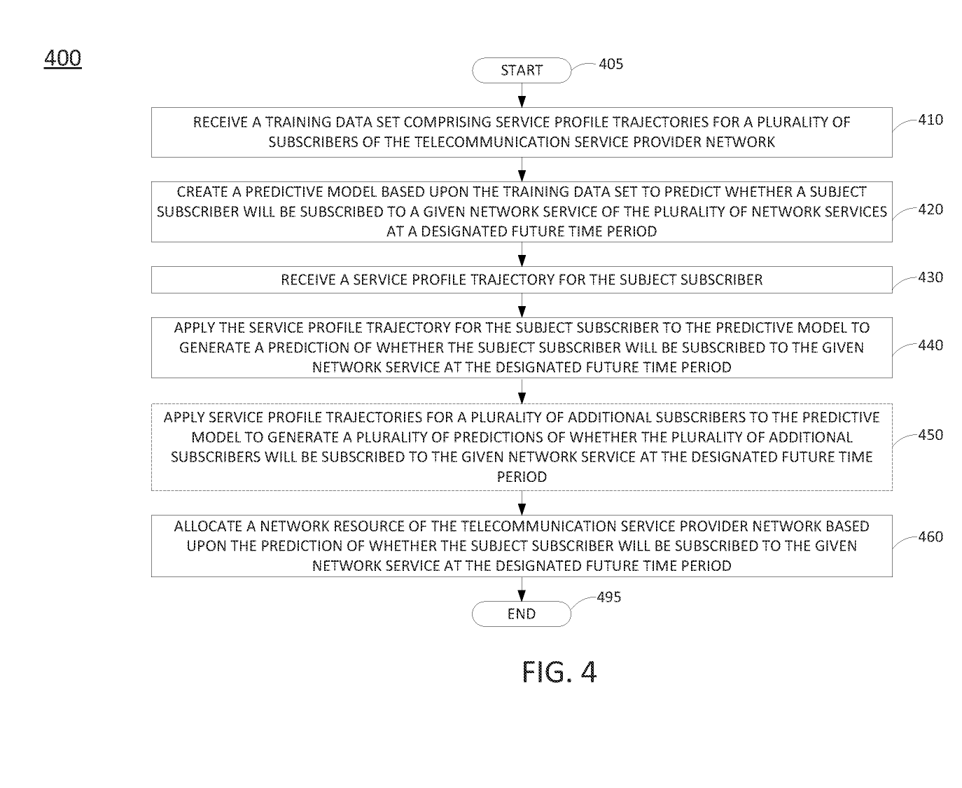

FIG. 4 illustrates an example flowchart of a method 400 for applying a network service profile trajectory for a subscriber to a predictive model to generate a prediction of whether the subscriber will be subscribed to a given network service at a designated future time period. In one example, the steps, operations, or functions of the method 400 may be performed by any one or more of the components of the system 100 depicted in FIG. 1. For instance, in one example, the method 400 is performed by the application server 135 or application server 152, or by application server 135 or application server 152 in conjunction with other components of the system 100. Alternatively, or in addition, one or more steps, operations or functions of the method 400 may be implemented by a computing device having a processor, a memory and input/output devices as illustrated below in FIG. 5, specifically programmed to perform the steps, functions and/or operations of the method. Although any one of the elements in system 100 may be configured to perform various steps, operations or functions of the method 400, the method will now be described in terms of an example where steps or operations of the method are performed by a processor, such as processor 502 in FIG. 5.

The method 400 begins at step 405 and proceeds to step 410. At step 410, the processor receives a training data set comprising network service profile trajectories for a plurality of subscribers of the telecommunication service provider network. In one example, each of the network service profile trajectories includes a network service profile of one of the plurality of subscribers over a plurality of time periods. For a given time period of the plurality of time periods, each of the network service profiles may include indications of whether a subscriber is subscribed to a plurality of network services of the telecommunication service provider network during the given time period. In one example, the plurality of time periods may include time periods following a release of the network service as a new service, e.g., in a test market of the telecommunication service provider network. The plurality of network services may include, for example: a wireless phone service, a wireless data service, a home phone service, a home broadband data service, a home television service, a satellite television service, a satellite data service, a data storage service, a home security monitoring service, and so forth.

In one example, the training data set further comprises customer demographic data over the plurality of time periods for the plurality of subscribers. The demographic data may include, for example: a subscriber's home address, zip code, region, etc., a number of members of a household, the constitution of the household members (e.g., number of adults, number of children, number of seniors, ages, sexes, etc.), an income and/or wealth tier, a number of network-connected devices utilized by the customer and/or household, the types of network-connected devices, occupation(s), and so forth. In one example, the training data set further comprises service usage data over the plurality of time periods for the plurality of subscribers. The service usage data may include, for example: information regarding trouble tickets generated with respect to telecommunication services for a subscriber, a number of phone calls made, received, answered, dropped, etc., a number of local and/or long distance calls made, an average call duration, a total number of voice call minutes utilized, a number of text messages sent, received, etc., a data volume utilized for home broadband service and/or mobile data service, records of excess network resource utilization, television channels and/or live programs viewed, particular media contents recorded, particular applications downloaded and/or installed on a customer's device, and so forth.

At step 420, the processor creates a predictive model based upon the training data set to predict whether a subject subscriber will be subscribed to a given network service of the plurality of network services at a designated future time period. In one example, the predictive model is further based upon the customer demographic data over the plurality of time periods and/or based upon the service usage data over the plurality of time periods. In various examples, the predictive model may comprise a binary classifier, a decision tree algorithm, or a distance-based classifier. In one example, the predictive model may further comprise a plurality of classifiers with regard to the given network service for a plurality of future time periods.

At step 430, the processor receives and/or gathers a network service profile trajectory for a subject subscriber. The network service profile trajectory may comprise, for example, a plurality of network service profiles of the subscriber for a total duration of time commensurate with a duration of the plurality of time periods. For instance, if the predictive model, or a classifier of the predictive model is to predict whether or not a subscriber is anticipated to be subscribed to the given network service at a time period six months in the future, the plurality of time periods associated with the training data set may comprise six time periods/intervals of one-month duration. In addition, the network service profiles for the given subscriber may comprise network service profiles from a six-month time period (which may, but need not overlap with the six time periods/intervals of one-month duration associated with the training data set. In one example, step 430 may further include gathering demographic data and/or service usage data for the given subscriber, e.g., associated with the same duration of time (and same overall time period) from which the plurality of network service profiles of the subscriber is gathered.

At step 440, the processor applies the network service profile trajectory for the subject subscriber to the predictive model to generate a prediction of whether the subject subscriber will be subscribed to the given network service at the designated future time period. In one example, step 440 may further include applying the demographic data and/or service usage data for the subject subscriber to the predictive model to generate the prediction. In one example, the prediction of whether the subject subscriber will be subscribed to the given network service at the designated future time period includes a confidence score of the prediction. Following step 440, the method 400 may proceed to step 460 or to optional step 450.

At optional step 450, the processor may apply additional network service profile trajectories for a plurality of additional subscribers to the predictive model to generate a plurality of predictions of whether the plurality of additional subscribers will be subscribed to the given network service at the designated future time period. In one example, optional step 450 may further include applying additional demographic data and/or service usage data for the plurality of additional subscribers to the predictive model to generate the plurality of predictions. In one example, the plurality of additional subscribers may be from a same region as the subject subscriber, a same market segment, and so forth.

At step 460, the processor allocates a network resource of the telecommunication service provider network based upon the prediction of whether the subject subscriber will be subscribed to the given network service at the designated future time period. It should be noted that the processor may allocate the network resource in cases where the prediction is that the subject subscriber will be subscribed to the given network service at the designated future time period as well as in cases where the prediction is that the subject subscriber will not be subscribed to the given network service at the designated future time period. In one example, the allocating the network resource of the telecommunication service provider network at step 460 is further based upon the plurality of predictions of whether the plurality of additional subscribers will be subscribed to the given network service at the designated future time period. For instance, where predictions are aggregated over a set of customers/households, e.g., a customer segment, it is possible to have overall percentages of households that are likely to drop a network service, add a network service, etc., and to allocate network resources based upon such information.

In one example, the network resource comprises a virtual machine deployed on network function virtualization infrastructure (NFVI) of the telecommunication service provider network. In another example, the network resource comprises a remote radio head (RRH) or a baseband unit (BBU). In one example, the allocation of the network resource may comprise automatically creating an entry or a ticket in a provisioning system or ordering system, e.g., to cause one or more new or additional physical components to be ordered, purchased, and/or deployed within the telecommunication service provider network in advance of an anticipated increase in network traffic as a result of new adoption(s) of the given network service.

In still another example, the network resource comprises a marketing automation platform, e.g., to present an offer to the subject subscriber via one or more communication modalities. In one example, the offer is presented to the subject subscriber prior to the designated future time period. For example, when the prediction is a prediction that the subject subscriber will not be subscribed to the given network service at the designated future time period and the subject subscriber was previously subscribed to the given network service, the processor may instruct the marketing automation platform to present an offer to the subject subscriber to maintain a subscription to the given network service. In another example, when the prediction is a prediction that the subject subscriber will be subscribed to the given network service at the designated future time period and the subject subscriber was not previously subscribed to the given network service, the processor may instruct the marketing automation platform to present an offer to the subject subscriber to subscribe to the given network service.

Following step 460, the method 400 proceeds to step 495 where the method ends. It should be noted that the method 400 may be expanded to include additional steps or may be modified to include additional operations with respect to the steps outlined above. For example, the method 400 may select whether to present offers to the subject subscriber via the marketing automation platform based upon a confidence score of the prediction, based upon when the designated future time period will occur and whether there are a number of additional subscribers who are predicted to drop/add the given network service prior to the designated future time at which the subject subscriber is anticipated to drop/add the network service, and so forth. In still another example, where the creation of the predictive model at step 420 may include generating additional classifiers for the given network service for a plurality of additional time periods, step 440 may further include applying the service profile trajectory for the subject subscriber (and in some cases demographic data and/or service usage data for the subject subscriber) to the additional classifiers to generate predictions regarding the plurality of additional time periods. In this way, the processor may determine not only if the subject subscriber is anticipated to be subscribed to the given network service at a static designated future time period, but may also determine a future time period in which the subject subscriber is first predicted to drop an existing network service or add a new network service. Furthermore, optional step 450 may be similarly expanded to apply customer service profile trajectories, demographics data, and/or service usage data for the plurality of additional subscribers to additional classifiers of the predictive model for the given network service for the plurality of additional time periods. For example, at optional step 450, the processor may similarly determine when one or more of the plurality of additional subscribers may be predicted to first drop an existing network service or to add a new network service.

In addition, although not specifically specified, one or more steps, functions or operations of the method 400 may include a storing, displaying and/or outputting step as required for a particular application. In other words, any data, records, fields, and/or intermediate results discussed in the method 400 can be stored, displayed and/or outputted either on the device executing the method 400, or to another device, as required for a particular application. Furthermore, steps, blocks, functions, or operations in FIG. 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 400 may comprise optional steps, or can be combined, separated, and/or performed in a different order from that described above, without departing from the examples of the present disclosure.

As such, the present disclosure provides at least one advancement in the technical field of telecommunication service provider network operations. This advancement is in addition to the traditional methods of human personnel manually guessing at network services which may be adopted by customers in the future and forecasting adoption rates based upon experience and intuition. In particular, examples of the present disclosure automatically: create a predictive model for a given network service and for a designated future time period based upon customers' network service profile data, demographic data, and/or service usage data; apply a network service profile trajectory, demographic data, and/or service usage data for a customer to the predictive model to generate a prediction of whether the customer will be subscribed to the given network service at the designated future time period; and allocate a network resource based upon the prediction. This leads to more efficient operating of the telecommunication service provider network, greater customer satisfaction, and better and more efficient use of human resources within an organization.

The present disclosure also provides a transformation of data, e.g., network service profile data, demographic data and/or service usage data is generated by one or more centralized system components. The operational data is gathered, stored, correlated, and analyzed, and is transformed into additional data or new data comprising a predictive model that can be used to generate predictions of whether additional customers/subscribers will or will not be subscribed to a given network service at a designated future time period. In addition, new data is generated insofar as allocating of a network resource based upon the results of applying the prediction model may cause new instructions to be generated and sent to configure NFVI, to activate a marketing automation platform, and so forth.

Finally, examples of the present disclosure improve the functioning of a computing device, e.g., a server. Namely, a server deployed in the telecommunication service provider network is improved by the use of network service profile data, demographic data, and/or service usage data that is generated by one or more centralized system components, which is processed via the operations of the present disclosure to create a predictive model for a given network service and for a designated future time period, apply a network service profile trajectory, demographic data, and/or service usage data for a customer to the predictive model to generate a prediction of whether the customer will be subscribed to the given network service at the designated future time period, and allocate a network resource based upon the prediction. Furthermore, the telecommunication service provider network is also transformed into a different state and/or has a different physical composition via the automatic allocation of one or more network resources in accordance with examples of the present disclosure.

FIG. 5 depicts a high-level block diagram of a computing device specifically programmed to perform the functions described herein. As depicted in FIG. 5, the system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for applying a network service profile trajectory for a subscriber to a predictive model to generate a prediction of whether the subscriber will be subscribed to a given network service at a designated future time period, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 400 as discussed above is implemented in a distributed or parallel manner for a particular illustrative example, i.e., the steps of the method, or the entire method is implemented across multiple or parallel computing devices, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The one or more hardware processors 502 can also be configured or programmed to cause other devices to perform one or more operations as discussed above. In other words, the one or more hardware processors 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method. In one example, instructions and data for the present module or process 405 for applying a network service profile trajectory for a subscriber to a predictive model to generate a prediction of whether the subscriber will be subscribed to a given network service at a designated future time period (e.g., a software program comprising computer-executable instructions) can be loaded into memory 504 and executed by hardware processor element 502 to implement the steps, functions or operations as discussed above in connection with the illustrative method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for applying a network service profile trajectory for a subscriber to a predictive model to generate a prediction of whether the subscriber will be subscribed to a given network service at a designated future time period (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A device, comprising:
a processor of a telecommunication service provider network; and
a computer-readable storage medium storing instructions which, when executed by the processor, cause the processor to perform operations, the operations comprising:
receiving a training data set comprising network service profile trajectories for a plurality of subscribers of the telecommunication service provider network, wherein each of the network service profile trajectories includes a network service profile of one of the plurality of subscribers over a plurality of time periods, wherein for a given time period of the plurality of time periods, each of the network service profiles includes indications of whether a subscriber is subscribed to a plurality of network services of the telecommunication service provider network during the given time period;
creating a predictive model based upon the training data set to predict whether a subject subscriber will be subscribed to a given network service of the plurality of network services at a designated future time period;
receiving a network service profile trajectory for the subject subscriber;
applying the network service profile trajectory for the subject subscriber to the predictive model to generate a prediction of whether the subject subscriber will be subscribed to the given network service at the designated future time period; and
allocating a network resource of the telecommunication service provider network based upon the prediction of whether the subject subscriber will be subscribed to the given network service at the designated future time period.

2. The device of claim 1, wherein the network resource comprises a virtual machine deployed on network function virtualization infrastructure of the telecommunication service provider network.

3. The device of claim 1, wherein the network resource comprises a remote radio head or a baseband unit.

4. The device of claim 1, wherein the network resource comprises a marketing automation platform.

5. The device of claim 4, wherein the marketing automation platform is to present an offer to the subject subscriber to maintain a subscription to the given network service, when the prediction is a prediction that the subject subscriber will not be subscribed to the given network service at the designated future time period and the subject subscriber was previously subscribed to the given network service.

6. The device of claim 5, wherein the offer is presented to the subject subscriber prior to the designated future time period.

7. The device of claim 4, wherein the marketing automation platform is to present an offer to the subject subscriber to subscribe to the given network service, when the prediction is a prediction that the subject subscriber will be subscribed to the given network service at the designated future time period and the subject subscriber was not previously subscribed to the given network service.

8. The device of claim 7, wherein the offer is presented to the subject subscriber prior to the designated future time period.

9. The device of claim 1, wherein the plurality of time periods includes time periods following a release of the given network service as a new service.

10. The device of claim 1, wherein the plurality of network services comprises at least two of:
a wireless phone service;
a wireless data service;
a home phone service;
a home broadband data service;
a home television service;
a satellite television service;
a satellite data service;
a data storage service; or
a home security monitoring service.

11. The device of claim 1, wherein the training data set further comprises customer demographic data over the plurality of time periods for the plurality of subscribers, wherein the predictive model is further based upon the customer demographic data over the plurality of time periods.

12. The device of claim 11, wherein the customer demographic data comprises at least one of:
a home address;
a zip code;
a region;
a number of household members;
a composition of a household;
an income tier;
a number of network-connected devices utilized by a customer; or
an occupation.

13. The device of claim 1, wherein the training data set further comprises service usage data over the plurality of time periods for the plurality of subscribers, wherein the predictive model is further based upon the service usage data over the plurality of time periods.

14. The device of claim 13, wherein the service usage data comprises at least one of:
information regarding trouble tickets generated with respect to telecommunication services for a subscriber;
a number of phone calls;
a number of long distance calls;
an average call duration;
a number of voice call minutes utilized;
a number of text messages;
a data volume utilized;
a record of excess network resource utilization;
a television channel viewed;
a program viewed;
a media content accessed; or
an application downloaded.

15. The device of claim 1, wherein the predictive model comprises a binary classifier or a decision tree algorithm.

16. The device of claim 1, wherein the predictive model comprises a distance-based classifier.

17. The device of claim 1, wherein the network service profile trajectory for the subject subscriber comprises a network service profile of the subject subscriber over a set of time periods commensurate in an overall duration with the plurality of time periods.

18. The device of claim 1, wherein the operations further comprise:
applying additional network service profile trajectories for a plurality of additional subscribers to the predictive model to generate a plurality of predictions of whether the plurality of additional subscribers will be subscribed to the given network service at the designated future time period, wherein the allocating the network resource of the telecommunication service provider network is further based upon the plurality of predictions of whether the plurality of additional subscribers will be subscribed to the given network service at the designated future time period.

19. A method, comprising:
receiving, by a processor of a telecommunication service provider network, a training data set comprising network service profile trajectories for a plurality of subscribers of the telecommunication service provider network, wherein each of the network service profile trajectories includes a network service profile of one of the plurality of subscribers over a plurality of time periods, wherein for a given time period of the plurality of time periods, the network service profiles includes indications of whether a subscriber is subscribed to a plurality of network services of the telecommunication service provider network during the given time period;
creating, by the processor, a predictive model based upon the training data set to predict whether a subject subscriber will be subscribed to a given network service of the plurality of network services at a designated future time period;
receiving, by the processor, a network service profile trajectory for the subject subscriber;
applying, by the processor, the network service profile trajectory for the subject subscriber to the predictive model to generate a prediction of whether the subject subscriber will be subscribed to the given network service at the designated future time period; and
allocating, by the processor, a network resource of the telecommunication service provider network based upon the prediction of whether the subject subscriber will be subscribed to the given network service at the designated future time period.

20. A non-transitory computer-readable storage medium storing instructions which, when executed by a processor of a telecommunication service provider network, cause the processor to perform operations, the operations comprising:
receiving a training data set comprising network service profile trajectories for a plurality of subscribers of the telecommunication service provider network, wherein each of the network service profile trajectories includes a network service profile of one of the plurality of subscribers over a plurality of time periods, wherein for a given time period of the plurality of time periods, the network service profiles includes indications of whether a subscriber is subscribed to a plurality of network services of the telecommunication service provider network during the given time period;
creating a predictive model based upon the training data set to predict whether a subject subscriber will be subscribed to a given network service of the plurality of network services at a designated future time period;
receiving a network service profile trajectory for the subject subscriber;
applying the network service profile trajectory for the subject subscriber to the predictive model to generate a prediction of whether the subject subscriber will be subscribed to the given network service at the designated future time period; and
allocating a network resource of the telecommunication service provider network based upon the prediction of whether the subject subscriber will be subscribed to the given network service at the designated future time period.
